(19) United States
(12) Patent Application Publication
(10) Pub. No.: US 2009/0255376 A1
(43) Pub. Date: Oct. 15, 2009

(54) APPARATUS FOR REMOVING CHILDPROOF CAPS

(76) Inventor: Kenneth Taylor, Dayton, IN (US)

Correspondence Address: Buchanan Intellectual Property Office LLC, P.O. Box 700, Perrysburg, OH, 43552-0700, US

(21) Appl. No.: 12/197,344

(22) Filed: Aug. 25, 2008

Related U.S. Application Data
(60) Provisional application No. 60/957,921, filed on Aug. 24, 2007.

(51) Int. Cl. B67B 7/00

(52) U.S. Cl. 81/3.2; 81/3.29

(57) ABSTRACT

An apparatus is provided for removing a childproof cap from a container having a locking mechanism, the apparatus, which is configured for one-handed operation, comprises a cap-engaging assembly wherein a first portion is urged toward a second portion that applies a force against the childproof cap when the container is maintained in a fixed position. The cap-engaging assemble further comprises a actuating mechanism, such as a caming mechanism, that is configured such that as the first portion is urged toward the second portion the cap is initially depressed in a linear direction until the actuating mechanism is engaged, whereby the second portion is rotated slightly relative to the first portion so that the childproof cap is also rotated and becomes disengaged from the locking mechanism of the container. The apparatus may optionally include a support apparatus that operatively connects the cap-engaging mechanism to a support base that receives the container, such as via a pivoting arm. In another embodiment, the apparatus includes a drive mechanism, such as an electric motor that rotates a threaded rod connected to the cap-engaging mechanism, thereby reducing the need for the user to supply the necessary force to depress and disengage the cap.

### CROSS REFERENCE TO RELATED APPLICATION

This application claims priority to U.S. Provisional Application Ser. No. 60/957,921, filed on Aug. 24, 2007, the entire contents of which are hereby incorporated by reference into this disclosure.

### FIELD

This invention relates container-opening devices, more particularly to devices for removing locking twist caps from containers.

### BACKGROUND

Since their invention in the 1940s, specially configured caps for containers, such as medicine bottles, have been available to help prevent young children from accidentally ingesting the contents, while not posing an significant obstacle to being opened by those having greater manual dexterity. The most common type of childproof container is one where the cap must be depressed and turned at the same time in order for it to become disengaged from the container, an action that is difficult for very young children to perform spontaneously. Unfortunately, some individuals, particularly the elderly or those with physical challenges, can have difficulty in unlocking such a cap mechanism.

U.S. Pat. No. 6,393,947 (Corcoran et al.) describes an apparatus for removing childproof caps that provides a separate gripping means for depressing the cap and another for causing simultaneous rotation of the container, requiring two-handed operation. While such an apparatus may allow some individuals to remove caps more easily, it does not completely fulfill the need for others with more limited abilities. What is needed is a childproof cap removal apparatus that is reliable when employing single-handled operation such that it can be used by individuals of a variety of physical challenges.

### SUMMARY OF EXEMPLARY EMBODIMENTS

The invention provides for an apparatus for removing a childproof cap from a container having a locking mechanism that inhibits detachment of the childproof cap, the apparatus comprising a cap-engaging assembly comprising a first portion and a second portion configured to be urged toward the one another to apply a force against and rotation of the childproof cap when the container is maintained in a fixed position. The cap-engaging assemble further comprises a actuating mechanism, such as a caming mechanism and preferably, but not necessarily includes a compressible mechanism or means (e.g., a compression or torsion spring) disposed between the first portion and the second portion. The cap-engaging assembly and actuating mechanism are configured such that as the first portion is urged toward the second portion, the cap is contacted by the latter such that there is downward linear movement of the childproof cap relative to the container. Further compression of cap-engaging mechanism against the cap results in the actuating mechanism causing rotation of the second portion that engages the cap as linear pressure is maintained so that the childproof cap becomes disengaged from the locking mechanism such that it may be readily lifted from the container.

In another aspect of the invention, the cap-engaging mechanism is connected to an arm that is pivotably attached to support apparatus comprising an upright portion that is connected to a base support that receives the childproof container. As the lever is depressed by the user, the first portion of the cap-engaging assembly is urged downward toward the second portion while compressing a spring mechanism that interconnects the two until a follower element located underneath the first portion contacts the caming element located on the second portion, thereby causing a deflection therebetween that twists the section portion in a counter-clockwise direction relative to the first portion so that the cap is rotated in a direction that causes disengagement of the locking mechanism.

In still another aspect of the invention, the upright portion of the support apparatus is configured to attach to a wall or other vertical surface, such as by suction cups, screws, or another well-known affixation means. The cap-engaging mechanism may be operatively connected to the upright portion of the support apparatus using a compression or tension spring so that once it has been manually depressed to accomplish the disengagement of the childproof container locking mechanism, it may resiliently return to its original starting position.

In yet another aspect of the invention, the apparatus does not include a support apparatus. Rather, the first portion is configured so that pressure is applied directly to the top of the first portion or structure attached thereto so that a spring is depressed relative to the second portion while the container rests on a surface or special pad. As pressure is maintained, the caming mechanism, a torsional spring, or another type of actuating mechanism causes rotation of the second portion to disengage the cap from the container.

In still yet another aspect of the invention, the apparatus includes an electro-mechanical drive mechanism, such as a small electric motor connected to a threaded rod that is received by the cap-engaging mechanism. Rotation of the threaded rod by the motor causes the cap-engaging mechanism to be lowered and come into contact with the cap of the container located on the base support. As the actuating mechanism is activated, the second portion of the cap-engaging mechanism causes the disengagement of the childproof container's locking mechanism. Reversal of the motor allows the cap-engaging assembly to return to its original position and allow removal of the container.

### BRIEF DESCRIPTION OF THE DRAWINGS

Embodiments of the present invention will now be described by way of example with reference to the accompanying drawings, in which:

FIGS. 1-2 depict perspective views of an illustrative embodiment of the present invention;

FIG. 3a-c depict side views of the caming mechanism of FIGS. 1-2;

FIG. 4 depicts a side view of a second embodiment of the present invention;

FIG. 5 depicts a side view a third embodiment of the present invention;

FIG. 6 depicts a side view of an alternative caming mechanism of the present invention.

FIG. 7 depicted a partially exploded view of an illustrative embodiment of the present invention comprising a motorized drive mechanism; and

FIG. 8 depicts an underside view of the cap-engaging mechanism of FIG. 7.

### DETAILED DESCRIPTION OF EXEMPLARY EMBODIMENTS

For the purposes of promoting an understanding of the principles of the invention, reference will now be made to the embodiments illustrated in the drawings, and specific language will be used to describe the same. It should nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other details of construction are believed to be well within the ability of one of even rudimentary skills in this area, in view of the present disclosure. The invention encompasses embodiments both comprising and consisting of the elements described with reference to the illustrative embodiments. Unless otherwise indicated, all ordinary words and terms used herein shall take their customary meaning as defined in The New Shorter Oxford English Dictionary, 1993 edition.

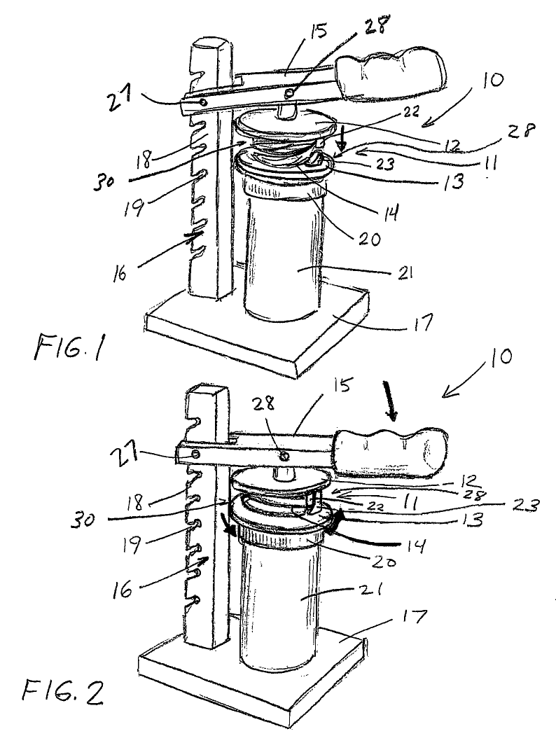

The present invention, as embodied in FIGS. 1-8 comprises a apparatus 10 for removing a childproof cap 20 from a container 21, such as a medicine bottle, the apparatus comprising a cap-engaging assembly 11 that includes a first portion 12 and a second portion 13 that include complimentary elements of an actuating mechanism 30 that it configured such as the first portion is manually depressed or urged relative to the second portion. As such, the second portion is caused to rotate, typically in a counter-clockwise direction after the actuating mechanism 30 becomes engaged. When the second portion 13, which preferably comprises a textured or other type of bottom surface adapted for gripping, is urged against a childproof cap 20 that is lockingly engaged to a container 21 resting on or against a surface, this two-part action of initially causing a downward force against the childproof cap 20, followed by rotational movement of the cap that shifts the locking tabs of the cap under and past the locking structure located along the outer top rim of the container (locking mechanism not shown). This allows the cap to become disengaged from the locking mechanism and container such that once the second portion 13 and the childproof cap are separated from one another, the cap can be readily lifted off of the container without further manipulation required. If the container 21 is prevented from rotational movement by frictional engagement between the bottom of the container and a slip-free surface, such as a appropriately configured base member 17, pad, 24, or secured by another means, the operation can be performed using only one hand, or only by applying force against the first portion 12 of the actuating mechanism 30 or structure connected thereto.

FIGS. 1-2 depict an exemplary embodiment of the present invention in which the first portion 12 of the cap-engaging assembly 11 is operatively connected to an arm 15 that in turn, is connected to a support structure 16 comprising an upright member 18 that is attached to a base support 17 configured for receiving and holding the container, the connection of the arm to the upright member comprising an interconnecting pivot mechanism 27, such as a pin or projections that are received within a hole and/or pair of recesses. The upright member includes a series of slots 19 that allow the height of the arm 15 and pivot mechanism 27 to be adjusted relative to the base support 17 to accommodate different sizes (heights) of containers 21. One skilled in the mechanical arms would recognize that other mechanisms for adjusting the location of the pivot mechanism 27, such as spring action pegs, etc., may be used.

The cap-engaging assembly 11 comprises the first portion 12, which is attached to the exemplary arm 15, such as by the illustrative pivoting connection 28 that helps maintain the first portion 12 at an optimal angle relative to the top of the childproof cap 20. The first portion 12 is interconnected to the second portion 13 of the cap-engaging assembly 11 by a compressible mechanism 14, such as the illustrative compression spring that allows the first portion 12 to be depressed downward to transfer force against the second portion 13 and the childproof cap 20 engaged therewith, releasing the force against the second portion 13 and cap 20 when the spring mechanism 14 is allowed to return to the original relaxed configuration. In addition to a single compression spring 14, a plurality of springs may be used or another compressive mechanism that allows the first portion 12 and second portion 13 to be resiliently moved into closer proximity to one another.

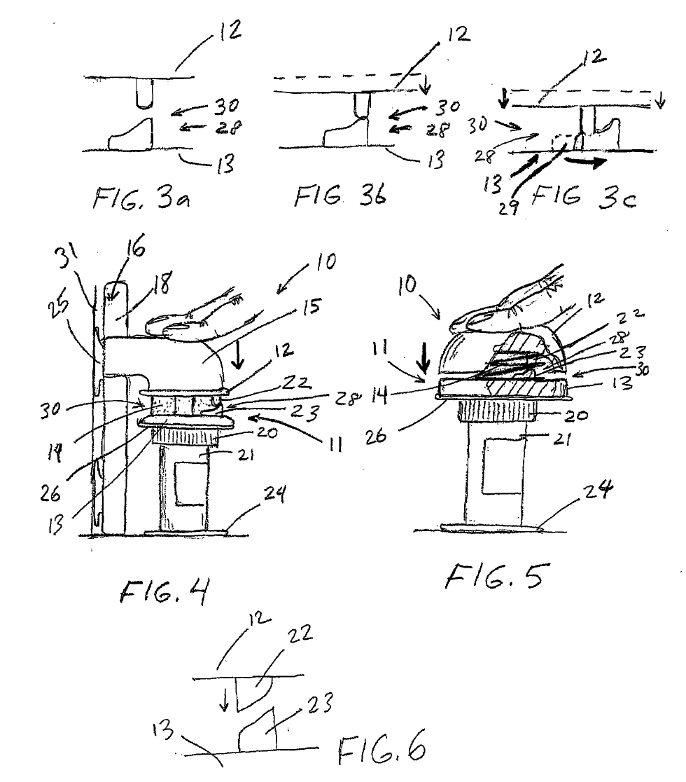

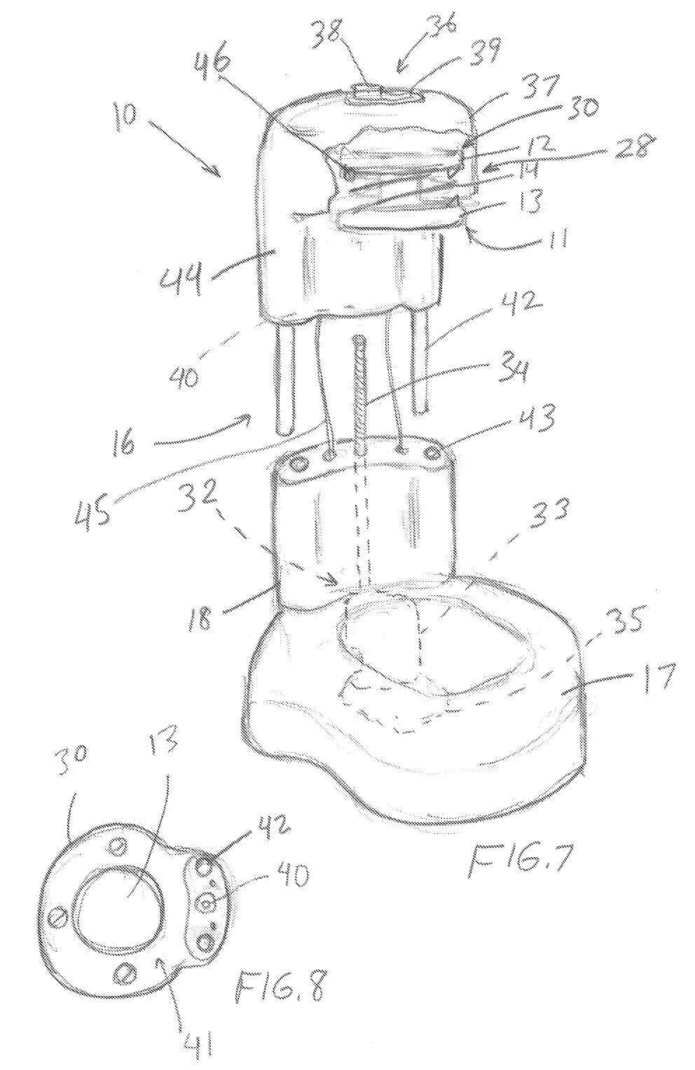

Another desired property of the compressive mechanism or element 14 is having it be able to undergo sufficient torsional or rotational movement such that the second portion 13 can be rotated at least a few degrees by the action of force being applied to the first portion 12. The illustrative compression spring 14 provides for the necessary two-part action of linear compression to supply the force that urges the tabs of the childproof cap downward to separate them from the locking structure along the container, then allowing for rotational movement of the second portion 13 relative to the first portion 12 such that the locking tabs are shifted to a portion, whereby when the downward force is removed, the tabs are aligned with slots located between the locking structure so that the cap can be lifted off of the container with relative ease. The second part of the two-part action, the rotational movement of the second portion 13 that completes the disengagement between the childproof cap and container (FIG. 2), is supplied by a caming mechanism 28 or other means in which linear force applied to the first portion 12, such as with the illustrative arm 15 or handle being pressed downward thereagainst, causing contact between a follower element 22 disposed on the underside of the first portion 12 and a caming element 23 disposed on the upper face of the second portion 23, best depicted in sequence of FIG. 3a-b. As the application of downward force continues, the follower 22 is deflected along a curvilinear surface of the caming element 23, which causes the second portion 13 to rotate for a distance 29 relative to the first portion 12 approximately equal to the distance the follower element 22 travels along the caming element 23, a distance that is sufficient to shift the locking tabs of the cap to align them with the open slots along the container 21. As an alternative to the illustrative caming mechanism, the follower element could be located on the second portion 13 instead of the first portion 12, or as depicted in FIG. 6, the two elements 22,23 of the caming mechanism 28 could be similar in configuration. In fact, one skilled in the mechanical arts would appreciate that a variety of caming mechanism could be selected or conceived that would allow for the second portion 13 to urge the childproof cap 20 downward relative to the container 20, followed by a caming action that rotationally realigns the childproof cap so that it can be removed therefrom. In addition to a caming mechanism 28 comprising a follower element 22 and caming element 23, as depicted, a torsion spring may be used that is wound such that is causes rotational movement when compressed. Since rotational movement of the second portion 13 and childproof cap 20 alone by design cannot cause the cap to disengage from the container 21, the compressible mechanism 14 comprising the torsion spring should be configured to allow an initial linear compression between the first and second portions 12,13 to separate the locking mechanism between cap and container. This feature could be designed into the spring itself, or the torsional spring could be used in combination with a compression spring or other compressible means which interconnects the first and second portion 12,13 and allows for linear compression, whereby the torsion spring is unconnected to the first portion and separated by a small gap therefrom such that there is a desired amount of linear compression before contact between the torsion spring and first portion causes the rotational movement of the second portion and childproof cap to commence. It should be noted that the first portion 12 could comprises two interconnected portions that rotate relative to one another such that at least a portion of actuating mechanism 30, such as that which is attached to the upper part of the compressible mechanism/spring, is attached to two portions of the apparatus 10 that rotate together while the grippable portion of the first portion remains stationary. Nevertheless, the actuating mechanism 30 should be still be interpreted as interconnecting the first and second portions 13 and cause rotational movement relative thereto in this particular instance.

While the embodiment of FIGS. 1-2 includes a cap-engagement mechanism connected to free-standing support apparatus 16, other configuration are contemplated, such as the apparatus of FIG. 4 in which the upright portion 18 of the support 16 is secured against an vertical surface 31, such as a wall by means of the illustrative suction cups 25 for ease of repositioning, or using a more permanent attachment such as screws or other anchoring means. In the illustrative embodiment, the base portion is eliminated in favor of an optional pad 25 placed on the horizontal surface which includes a tacky, textured, or other optimized surface for gripping the bottom of the container, thereby reducing or eliminating the need for manually gripping the container to prevent its rotation. Other features of the present embodiment include a non-pivoting arm 15 that is manually urged straight downward to cause the cap-engaging mechanism 30 to contact the childproof cap 20. An appropriately configured tension spring attached above the arm 15, or a compression spring attached below the arm (neither shown) would allow the arm to return to a initial portion in which the second portion 13 does not contact the top of the childproof cap 20, when the latter is positioned therebelow. Also depicted, the compressible mechanism 14 comprises a plurality of resiliently compressible foam columns that allow for both linear compression and sufficient twisting to accommodate the necessary rotational movement of the second portion 13 relative to the first portion 12 to which they are attached.

FIG. 5 depicts and embodiment that does not include a support apparatus 16 or arm 15 to supply the downward force to activate the actuating mechanism 30. Rather, the actuating mechanism comprising the interconnected first and second portions 12,13 is positioned over and against the top of the childproof cap and container 20,21 (preferably with a pad 24 or appropriate surface underneath) and force is applied manually directly to the first portion, with the resulting action working much like that depicted in FIGS. 1-2. It should be noted that the illustrative embodiment could be configured such that the first or the section portions 12,13 are both configured to be held by the user, as well as being able to engage a surface of the cap and container to cause disengagement of the locking mechanism. For example, the second portion 13 could be maintained stationary by the user while the bottom of the container is set on the upper surface of the first portion 12 and the top of the cap urged against a horizontal surface, such as the underside of a cabinet. If such an apparatus was inverted, the cap and container would be inverted as well for disengagement to be possible. By eliminating the arm and support 15, the embodiment of FIG. 5 has the advantage of being perhaps more portable and versatile than the embodiments of FIGS. 1-2, and 4.

To eliminate the need for a physically challenged individual having to manually depress the first portion of the apparatus to urge it toward the second portion to contact and loosen the cap, the present invention may be configured to include a drive mechanism 32 comprising a small electric motor 33 or other electro-mechanical means to fulfill that function, as depicted in the embodiment of FIG. 7. In the illustrative embodiment, the drive mechanism 32 includes a standard electric motor 33, disposed within the base support 17 of the support structure 16, that drives a threaded rod 34 connected thereto by a series of gears that permit the threaded rod to be rotated at the appropriate speed. Power to the motor is supplied by a battery pack 35 or other DC power source that is situated within the lower housing or alternatively, partially or completely external thereto. Alternatively, the apparatus could be configured to operate using AC current or less-traditional energy sources, although the power needs of this embodiment would be minimal. In the illustrative embodiment, a switching mechanism 36 is located on the top surface of the outer housing 37 of the actuating mechanism 30 comprising the cap-engaging assembly 11. The switching mechanism 36 includes a first switch 38 that is depressed or otherwise actuated to rotate the threaded rod 34, which is received by a threaded nut 40 affixed to and located on the underside 41 of the outer housing 37 (FIG. 8), thus causing the cap-engaging assembly 11 to be urged downward toward the base support 17 with rotation of the threaded rod 34. The upright member 18 of the support structure 16 is configured to slidably receive the actuating mechanism 30 comprising the cap-engaging assembly 11 via two posts 42 that extend downward from the lower portion 44 of the outer housing 37 and are slidably received into two channels 43 located about the upright member 18. Adjacent channels may dedicated for wires 45 extending from the switches and/or sensors 46 that lead to the battery pack 35 or power supply. As the rod 34 continued to rotate, the lower portion 44 of the outer housing 37 of the actuating mechanism 30 slides downward over the upright member 18 extending from the base support as the spring (compressible element 14) is compressed, allowing the first and second portions 12,13 of the cap-engaging assembly 11 to come into contact with one another via the caming mechanism 28 such that the cap-removal process can be accomplished as similar to that described for the previous embodiments. After the container 21 with the loosened cap 20 is removed from the base support 17, a second switch 39 of the switch assembly 36 may be activated to cause the rod 34 to reverse its original direction of rotation so that the cap-engaging assembly is urged upward and the apparatus 10 is available to receive another container. Alternatively, the drive apparatus 32 could be configured such that once the second portion 13 of the actuating mechanism 30 has rotated and loosened the cap 21, a sensor 46 senses the rotation of the second portion and signals the motor 33 of the drive mechanism 32 to reverse its direction automatically so that the actuating mechanism 30 is returned to its original starting position upon completion of the operation. One skilled in the mechanical arts would appreciate that the illustrative drive mechanism 32 is merely exemplary and that there are other known mechanical or electro-mechanical systems that could be adapted or configured to raise or lower the actuating mechanism 30 of the present invention or cause the first and second portions 12,13 to move into approximation to one another to reduce or eliminate the need for manual force supplied by the user.

While the preferred is therefore intended that the foregoing detailed description be regarded as illustrative rather than limiting, and that it be understood that it is the following claims, including all equivalents, that are intended to define the spirit and scope of this invention.

What is claimed is:

1. An apparatus for removing a childproof cap from a container having a locking mechanism therebetween inhibiting detachment of the childproof cap, comprising:
a cap-engaging assembly comprising a first portion and a second portion, at least one of the first and second portion being configured to be urged toward the other of the first and second portion to apply a force against and rotation of the childproof cap when the container is maintained in a fixed position; and
wherein the cap-engaging assemble further comprises a actuating mechanism disposed between the first portion and the section portion that is configured such that as the first portion is urged toward the section portion, thereby causing supplying pressure against the childproof cap engaged with the apparatus and resulting in linear movement of the childproof cap relative to the container engaged therewith by the locking mechanism, the first and section portion are configured such further compression therebetween results in the actuating mechanism causing rotation of the one of the first and section portions engaged with the childproof cap so that the childproof cap becomes disengaged from the locking mechanism such that it may be readily lifted from the container.

2. The apparatus of claim 1, wherein the cap-engaging assembly is connected to a movable arm connected to a support apparatus.

3. The apparatus of claim 1, wherein the cap-engaging assembly comprises a compressible mechanism.

4. The apparatus of claim 1, wherein the compressible mechanism comprises a spring.

5. The apparatus of claim 1, wherein the compressible mechanism comprises a compressible foam.

6. The apparatus of claim 1, wherein the caming mechanism comprises a first element disposed on the first portion of the cap-engaging assembly and a second element disposed on the section portion thereof, the first element configured to engage the second element during compression of the compressible means and cause rotation of the section portion relative to the first portion as the childproof cap is depressed.

7. The apparatus of claim 1 further comprising a drive mechanism that at least partially assists the user in urging the cap-engaging mechanism in a direction toward the childproof cap and container.

8. The apparatus of claim 1, wherein the drive mechanism comprises an electric motor.

9. The apparatus of claim 8, wherein the drive mechanism further comprises a threaded rod connected to the electric motor which is disposed within a support apparatus, wherein the threaded rod is operatively connected to the cap-engaging assembly such that rotation of the threaded rod causes the cap-engagement assembly to move relative to the support apparatus to which it is slidably engaged.

10. An apparatus for removing a childproof cap from a container having a locking mechanism therebetween, comprising:
a support apparatus comprising a base portion;
a cap-engaging assembly connected to the support apparatus, the cap-engaging assembly comprising a head member having a face configured for contacting and applying pressure to a top surface of the cap; and a compressible element disposed between the movable arm and the face member that is configured to resiliently compress as the head member contacts the cap of the container upon actuation of the movable arm; and
a cam mechanism, including a caming element and a follower element, at least a portion of the cam mechanism being associated with the cap-engaging assembly, the cam mechanism configured such that upon at least partial compression of the compressible element during engagement between the head member and the cap, causing downward movement of the cap relative to the container, the follower element is received by the cam element to cause rotation of the head member and the cap engaged therewith such that the cap becomes disengaged from the locking mechanism and decoupled from the container; thereby allowing the cap to be lifted away without further manipulation thereof.

11. The apparatus of claim 6, wherein the cam mechanism is activated only after partial compression of compressible element, such that the portion of the locking mechanism located about the childproof cap can be physically separated from the portion of the locking mechanism of the container prior to rotation of the childproof cap provided by the caming mechanism relative to the container, such that the childproof cap can be readily removed from the container.

12. The apparatus of claim 6, wherein the caming element comprises a sloped configuration adapted to defect the follower upon contact therewith, such that the section portion is rotated relative to the first portion.

13. The apparatus of claim 1, wherein both the caming element and follower comprise a sloped configuration such that they deflect one another upon contact.

14. The apparatus of claim 10 further comprising a drive mechanism that at least partially assists the user in urging the cap-engaging mechanism in a direction toward the childproof cap and container.

15. The apparatus of claim 14, wherein the drive mechanism comprises an electric motor.

16. The apparatus of claim 15, wherein the drive mechanism further comprises a threaded rod connected to the electric motor disposed within a support apparatus, wherein the threaded rod is operatively connected to the cap-engaging assembly such that rotation of the threaded rod causes the cap-engagement.

17. The apparatus of claim 10, wherein the apparatus comprises an arm that operatively connects the cap-engaging mechanism to the support apparatus.

18. The apparatus of claim 10, wherein the support apparatus comprises spring member that is configured to resiliently urge the cap-engaging mechanism away from the container after disengagement of the locking mechanism thereof.
